(19) United States
(12) Patent Application Publication
(10) Pub. No.: US 2002/0149265 A1
(43) Pub. Date: Oct. 17, 2002

(54) Apparatus for uninterrupted power supply including a fuel cell

(76) Inventor: Harald Gosebruch, Verden (DE)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/118,685

(22) Filed: Apr. 8, 2002

(30) Foreign Application Priority Data
Apr. 12, 2001 (DE) 10118353.4-45

(51) Int. Cl. H02J 7/00

(52) U.S. Cl. 307/66

(57) ABSTRACT

An apparatus for uninterrupted power supply includes a hydrolysis unit being designed and arranged to locally produce hydrogen from water, a storage unit being designed and arranged to store the hydrogen, and a fuel cell being designed and arranged to produce power by cold oxidation of the hydrogen to water during failure of a main power supply. Particularly, the apparatus is suitable for remote units such as sending/receiving stations for cellular phone services. Typically, such sending/receiving stations or repeaters are supplied with power by a power supply network. When the power supply network fails, the uninterrupted power supply system serves to guarantee power supply for a certain period of time.

### CROSS REFERENCE TO RELATED APPLICATIONS

This application claims the benefit of co-pending German Patent Application No. 101 18 353.4-45 entitled “Vorrichtung zur unterbrechungsfreien Stromversorgung mit einer Brennstoffzelle”, filed on Apr. 12, 2001.

### FIELD OF THE INVENTION

The present invention generally relates to an apparatus for uninterrupted power supply. More particularly, the present invention relates to an apparatus for uninterrupted power supply including a fuel cell for producing power by cold oxidation of hydrogen to water during failure of a main source of power. The present invention particularly relates to an uninterrupted power supply system for remote units. Such remote units—for example sending/receiving stations for cellular phone services—are also called repeaters. Such sending/receiving stations are typically supplied with power by a power supply network. When the power supply network fails, the uninterrupted power supply system serves to guarantee power supply for a certain period of time.

### BACKGROUND OF THE INVENTION

Apparatuses for uninterrupted power supply are generally known in the art.

An uninterrupted power supply system is known from European Patent No. EP 0 855 098 B1 which corresponds to International Application PCT/EP96/04340 published as WO 97/15106 and to U.S. Pat. No. 6,011,324. The known system includes a pressure reservoir tank to store hydrogen as gas and a fluid tank to store methyl alcohol from which hydrogen may be released by a reformer. The known apparatus includes a fuel cell to supply power during short time failures of the main source of power. Therefore, the fuel cell maintains its standby position. The consumption of hydrogen is small, but it is substantial when seen over longer periods of time.

With respect to remote units—for example sending/receiving stations for cellular phone services—presently known uninterrupted power supply systems include accumulators or storage batteries which are used as electric energy storage units. Such known accumulators are limited with respect to the period of time during which they guarantee correct power supply. Furthermore, the durability or usable lifetime during which they reliably fulfill their function is comparatively short. Typically, it is between approximately 4 to 6 years. This means that substantial maintenance services are presently required for many thousand sending/receiving stations for cellular phone services in each country.

### SUMMARY OF THE INVENTION

The present invention relates to an apparatus, a system and a method for uninterrupted power supply. The apparatus includes a hydrolysis unit being designed and arranged to locally produce hydrogen from water, a storage unit being designed and arranged to store the hydrogen, and a fuel cell being designed and arranged to produce power by cold oxidation of the hydrogen to water during failure of a main power supply. The method includes the steps of locally producing hydrogen from water in a hydrolysis unit, locally storing the hydrogen, and locally producing power by cold oxidation of the hydrogen to water.

With the novel apparatus for uninterrupted supply power, it is possible to operate remote systems at decreased maintenance service intervals. The novel apparatus uses a hydrolysis unit to locally produce hydrogen from water at the place of installation of the apparatus.

In the novel apparatus, the fuel cell is not supplied with hydrogen by an external hydrogen supply system. Instead, the hydrogen is produced within the novel uninterrupted current supply system. For this purpose, a hydrolysis unit or a hydrolyser is used, the hydrolysis unit being designed and arranged to split water into hydrogen and oxygen at the place of installation of the apparatus, the hydrogen then serving to supply the fuel cell. The fuel cell may also use the oxygen produced by the hydrolysis unit. Due to the fact that water is produced during oxidation of the hydrogen in the fuel cell, a closed circuit for the water may be realized to reuse the water. Even when there are losses of hydrogen or of water in the circuit, a comparatively small reservoir tank is sufficient to compensate for these losses. Additionally, water usually is available at the place of installation. In this way, the novel system especially differs from any conventional uninterrupted power supply system including a fuel cell or an internal combustion engine with respect to the fact that it does not depend on external fuel supply. Hydrogen necessary for the fuel cell does not have to be refilled from the outside even after long term usage of the novel system due to a failure of the power supply network.

Generally, the fuel cell of the novel apparatus itself may be designed and arranged to be operable as the hydrolysis unit when connecting it to electric potential from the main source of power. However, realizing this double function of the fuel cell has the disadvantage of a comparatively long period of time being required for starting the fuel cell for the production of power when it is presently used as the hydrolysis unit. Furthermore, the units for the gas of the fuel cell are comparatively complicated when designing it to fulfill the double function.

Consequently, it is preferred to design the novel apparatus in a way that the hydrolysis unit is a separate component in addition to the fuel cell. The hydrolysis unit or the hydrolyser may have a special design to fulfill its function of producing hydrogen. The supply of gas for the novel apparatus is easy to be realized. The fuel cell may be held in the standby modus to realize shorter reaction times during failure of the main source of power.

The hydrogen produced by the hydrolysis unit may be stored in a hydride storage unit in the novel system. It is known that hydride storage units have a comparatively long loading term when their capacity is to be fully used. However, this is no problem to the novel apparatus since there is no necessity of producing great amounts of hydrogen with the hydrolysis unit within short times. Instead, it is advantageous to use the hydrolysis unit only for the production of comparatively small amount of hydrogen per time unit.

It is also possible to arrange a fluid tank as storage unit for the hydrogen. In this case, a converter derives a storage fluid from the locally produced hydrogen. The storage fluid may be stored in the fluid tank. A reformer serves to supply the fuel cell with hydrogen recovered from the storage fluid. A storage fluid used in this exemplary embodiment of the novel uninterrupted power supply unit is, for example, methyl alcohol. The storage fluid may be produced using hydrogen and carbon dioxide from the air, and it may then be easily stored in the fluid tank. The volume necessary for a certain amount of hydrogen is only small compared to direct storage of hydrogen.

When a condenser and a return conduit for the water occurring in the condenser leading back to the hydrolysis unit are arranged for the exhaust gas of the fuel cell (which is steam), the novel system includes the above-described closed water circuit. The hydrolysis unit may be alternatively associated with a water tank either having a comparatively great capacity being sufficient to supply water for many years, or which is automatically refilled by rain and/or by groundwater. The hydrolysis unit of the novel system may be designed to be very small without having a negative influence on its function. A nominal power of less than approximately 19% or even of less than approximately 5% of the nominal power of the generator of the novel system is sufficient since the hydrolysis unit may locally produce the hydrogen over long periods of time during which the power supply network serves as main power source.

It is not necessary that the hydrolysis unit is supplied with current by the main source of power. It is also possible that the hydrolysis unit is supplied by additional solar cells and the like. However, such an arrangement requires additional structural expenditure. Consequently, it is preferred to supply the hydrolysis unit for the local production of hydrogen with power by the main source of power. It is to be understood that the hydrolysis unit will be automatically deactivated as soon as the associated hydrogen tank has been filled.

The hydrolysis unit may have a variety of different designs. Preferably, it is designed as a modern hydrolysis unit including a polymer electrolyte membrane.

To compensate for short term failures of the main power supply until full activation of the fuel cell, a condenser battery may serve as electric energy storage unit.

The novel apparatus may include a control unit to control its correct function and to prevent undesired locking of movable elements as gas valves, for example. The control unit may be designed and arranged to activate the novel system for a short time after a predetermined period of time. However, when the novel system is designed to have a permanent standby modus of the fuel cell, such a control unit is not required.

Other features and advantages of the present invention will become apparent to one with skill in the art upon examination of the following drawings and the detailed description. It is intended that all such additional features and advantages be included herein within the scope of the present invention, as defined by the claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1 is a view of a first exemplary embodiment of the novel apparatus for uninterrupted power supply.

FIG. 2 is a view of a second exemplary embodiment of the novel apparatus for uninterrupted power supply.

FIG. 3 is a single line flow diagram of the novel apparatus for uninterrupted power supply.

### DETAILED DESCRIPTION

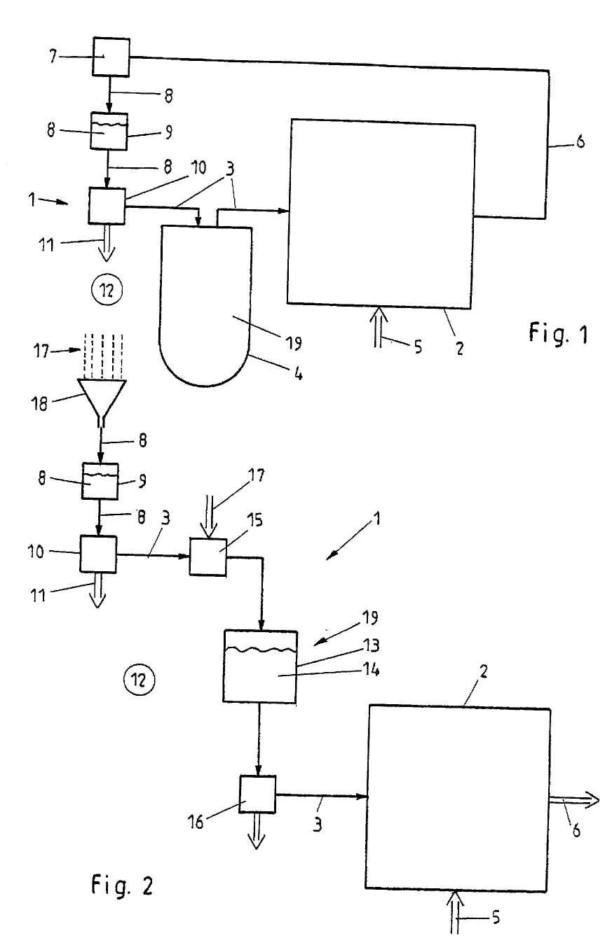

Referring now in greater detail to the drawings, FIG. 1 illustrates the most important elements of a novel apparatus 1 for uninterrupted power supply. In the following, the apparatus 1 may also be called a no-break power supply system. The apparatus 1 includes a fuel cell 2 which serves to supply power to a resistance or to a consumer when a main source of power fails, for example, an electricity production network. The resistance, the main source of power and all electric connections are not illustrated in FIG. 1. They have conventional designs well known in the art such that they do not need to be explained with respect to the present invention. The fuel cell 2 produces power and current, respectively, due to cold oxidation of hydrogen 3. In the illustrated embodiment of the apparatus 1, the hydrogen 3 is delivered by a hydrogen storage unit 4. In the illustrated embodiment of the apparatus 1, oxygen is supplied to the fuel cell by atmospheric oxygen contained in the air. The steam 6 contained in the exhaust gas of the fuel cell 2 is condensed in a condenser 7 to form water 8 to be fed to a water tank 9. The water tank 9 serves as a reservoir for a hydrolysis unit 10. The hydrolysis unit 10 serves to split up the water 8 into hydrogen 3 and oxygen 11 under the influence of electric potential. While the oxygen 11 is delivered into the atmosphere 12, the hydrogen 3 is fed to the hydride storage unit 4. In this way, the circuit for the hydrogen 3 is completed or closed. However, the circuit does not necessarily have to operate continuously, but instead only presently required partial steps are to be taken. In the case of an occurring failure or malfunction of the main source of power, the fuel cell 2 produces power by using the hydrogen 3. The hydrolysis unit 10 does not produce additional hydrogen 3 at the same time since the required electric energy is not available due to failure of the main source of power. Emergency production of hydrogen 3 is realized when the main source of power has become active, again, to supply power, and when the electric energy is sufficient for the intended use. Due to the fact that failures of the main power supply happen rather rarely, a comparatively long period of time may be used to refill the hydride storage unit 4 by the hydrolysis unit 10. Consequently, the hydrolysis unit 10 may be designed to be comparatively small in a way that it does not require a lot of power supplied by the main source of power.

For using the maximum hydrogen storage capacity of the hydride storage unit 4, it is advantageous to load it with hydrogen 3 rather slowly. When the fuel cell 2 remains in its standby operational mode even when the resistance is supplied by the main source of power to enable the fuel cell 2 to quickly reach its full power during failure of the main source of power, the hydrolysis unit 10 needs to have a substantially greater nominal power than the idle power of the fuel cell 2. The fuel cell 2 is to be designed in a way that it is capable of fulfilling the function of supplying the resistance with power during failure of the main source of power. Consequently, there is a proportion of the nominal power of the hydrolysis unit 10 with respect to the one of the fuel cell 2 of typically between approximately 1:10 up to approximately 1:100.

In the illustrated exemplary embodiment of the novel apparatus 1, the hydrolysis unit 10 as well as the fuel cell 2 includes a polymer electrolyte membrane. The fuel cell 2 may be designed as a parallel arrangement of single fuel cell units—for example in the form of a so called stack—which produces an increased output voltage compared to a single step fuel cell. In this way, the distribution voltage of a small sending/receiving station for cellular phone service—a so called repeater—of 48 Volt may be provided without transformation.

FIGS. 1 and 2 do not show the electric connections and valves being located in the illustrated conduits and associated control units. However, these elements are conventional, and a person with skill in the art easily knows how to arrange these elements.

The exemplary embodiment of the novel system 1 according to FIG. 2 differs from the one of FIG. 1 with respect to the fact that the storage unit for the hydrogen 3 is a fluid tank 13 for methyl alcohol. A converting unit 15 is arranged upstream of the fluid tank 13, and a reformer 16 is located downstream of the fluid tank 13. The converting unit 15 converts hydrogen 3 coming from the hydrolysis unit 10 into the methyl alcohol 14 by using carbon dioxide 17 from the atmosphere 12. The reformer 16 recovers the hydrogen 3 from the methyl alcohol 14 by releasing carbon dioxide 17. The described arrangement has the advantage of allowing for simple and compact storage of comparatively great amounts of hydrogen. Another difference compared to the uninterruptible power supply system 1 according to FIG. 2 compared to the one of FIG. 1 is that it does not include a condenser 7 for the steam 6 of the fuel cell 2. This means that a separate circuit for the hydrogen 3 is not required. Instead, the hydrolysis unit 10 is supplied by rain 17 being collected by a collector 18.

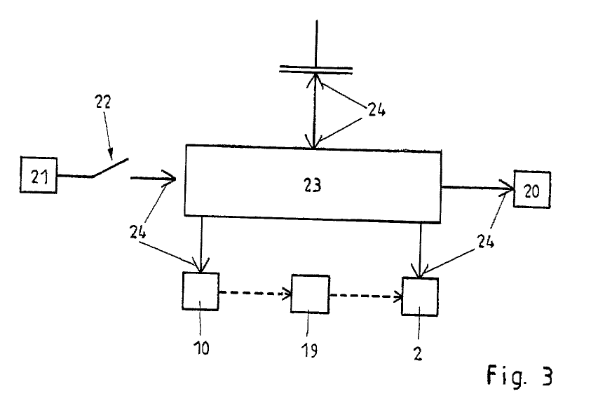

The single line electric flow diagram of FIG. 3 corresponds to the exemplary embodiments of the novel system 1 of FIGS. 1 and 2. FIG. 3 also shows the storage unit 19 for the hydrogen 3. A dashed line serves to indicate that hydrogen 3 is passed from the hydrolysis unit 10 to the fuel cell 2 via the storage unit 4, 13. It is to be seen in the single line electric flow diagram that a resistance 20 is supplied with power either by an external main source of power 21 or by the fuel cell 2. Next to a switch 22, a control unit 23 is arranged between the resistance 20 and the main source of power 21. The control unit 23 selectively causes electric connections between the single electric components of the uninterruptible power supply system 1. The direction of the arrows 24 indicates the directions of occurring energy flows. Pure control connections to the elements and between the elements, respectively, are not illustrated. However, these connections are well known to a person with skill in the art.

During normal function of the main source of power 21, the switch 22 is closed (opposite to the opened position illustrated in FIG. 3) such that the control unit 23 is fed by the main source of power 21. The control unit 23 supplies the resistance 20. Furthermore, it operates the hydrolysis unit 10 for the production of hydrogen 3 until the storage unit 19 is filled. The fuel cell 2 is held in its standby operational modus in which it has a certain idle phase consumption of hydrogen 3 such that the hydrolysis unit 10 has to fill the storage unit 19 from time to time even when the main source of power 21 does not fail.

When the main source of power 21 fails, the switch 22 is opened (as illustrated in FIG. 3). Now, the control unit 23 serves to supply the resistance 20 with power being produced by the fuel cell 2. To compensate the period of time until the output power of the fuel cell 2 has reached its maximum, a condenser battery 25 is arranged to serve as an electric short time energy storage unit. When the main source of power 21 is available, again, the switch 22 is moved to reach its closed position. Then, the fuel cell 2 is inactivated. In the following, the storage unit 19 is filled with hydrogen 3 by the hydrolysis unit 10.

The novel system 1 may be easily maintained, and it is designed for long periods of time between maintenance services. Furthermore, it may be used indoor without having to use an exhaust conduit leading to the outside since there are no dangerous exhaust gases even in the case of an opened hydrogen circuit.

Many variations and modifications may be made to the preferred embodiments of the invention without departing substantially from the spirit and principles of the invention. All such modifications and variations are intended to be included herein within the scope of the present invention, as defined by the following claims.

I claim:

1. An apparatus for uninterrupted power supply, comprising:
a hydrolysis unit being designed and arranged to locally produce hydrogen from water;
a storage unit being designed and arranged to store the hydrogen; and
a fuel cell being designed and arranged to produce power by cold oxidation of the hydrogen to water during failure of a main power supply.

2. The apparatus of claim 1, wherein said fuel cell is designed and arranged to be operated as said hydrolysis unit by connecting it to an electric potential of the main source of power.

3. The apparatus of claim 1, wherein said hydrolysis unit is designed as a separate element in addition to said fuel cell.

4. The apparatus of claim 1, wherein said storage unit is designed as a hydride storage unit.

5. The apparatus of claim 2, wherein said storage unit is designed as a hydride storage unit.

6. The apparatus of claim 3, wherein said storage unit is designed as a hydride storage unit.

7. The apparatus of claim 1, further comprising:
a converter being designed and arranged to produce a storage fluid from the locally produced hydrogen; and
a reformer being designed and arranged to supply said fuel cell with hydrogen by recovering hydrogen from the storage fluid, said storage unit being designed as a fluid tank unit to contain the storage fluid.

8. The apparatus of claim 2, further comprising:
a converter being designed and arranged to produce a storage fluid from the locally produced hydrogen; and
a reformer being designed and arranged to supply said fuel cell with hydrogen by recovering hydrogen from the storage fluid, said storage unit being designed as a fluid tank unit to contain the storage fluid.

9. The apparatus of claim 3, further comprising:
a converter being designed and arranged to produce a storage fluid from the locally produced hydrogen; and
a reformer being designed and arranged to supply said fuel cell with hydrogen by recovering hydrogen from the storage fluid, said storage unit being designed as a fluid tank unit to contain the storage fluid.

10. The apparatus of claim 1, further comprising:
a condenser being designed and arranged to condense exhaust gases of said fuel cell to water; and
a return conduit being designed and arranged to guide the water from said condenser to said hydrolysis unit.

11. The apparatus of claim 2, further comprising:
a condenser being designed and arranged to condense exhaust gases of said fuel cell to water; and
a return conduit being designed and arranged to guide the water from said condenser to said hydrolysis unit.

12. The apparatus of claim 3, further comprising:
a condenser being designed and arranged to condense exhaust gases of said fuel cell to water; and
a return conduit being designed and arranged to guide the water from said condenser to said hydrolysis unit.

13. The apparatus of claim 1, further comprising a rain supply unit being associated with said hydrolysis unit to supply water to said hydrolysis unit.

14. The apparatus of claim 1, further comprising a groundwater supply unit being associated with said hydrolysis unit to supply water to said hydrolysis unit.

15. The apparatus of claim 1, wherein said hydrolysis unit has a nominal power which is less than approximately 10 percent of the nominal power of said fuel cell.

16. The apparatus of claim 1, wherein said hydrolysis unit includes a polymer electrolyte membrane.

17. The apparatus of claim 1, further comprising a condenser battery being designed and arranged to serve as an electric energy storage unit.

18. An uninterrupted power supply system, comprising:
a hydrolysis unit being designed and arranged to produce hydrogen from water within said system; and
a fuel cell being designed and arranged to produce power by cold oxidation of the hydrogen to water.

19. The system of claim 18, further comprising a storage unit being designed and arranged to store the hydrogen produced by said hydrolysis unit.

20. The system of claim 19, wherein said storage unit is designed as a hydride storage unit.

21. The system of claim 19, further comprising:
a converter being designed and arranged to produce a storage fluid from the hydrogen; and
a reformer being designed and arranged to supply said fuel cell with hydrogen by recovering hydrogen from the storage fluid, said storage unit being designed as a fluid tank unit to contain the storage fluid.

22. The system of claim 19, further comprising:
a converter being designed and arranged to produce a storage fluid from the hydrogen; and
a reformer being designed and arranged to supply said fuel cell with hydrogen by recovering hydrogen from the storage fluid, said storage unit being designed as a fluid tank unit to contain the storage fluid.

23. The system of claim 18, further comprising:
a condenser being designed and arranged to condense exhaust gases of said fuel cell to water; and
a return conduit being designed and arranged to guide the water from said condenser to said hydrolysis unit.

24. The system of claim 18, further comprising a rain supply unit being associated with said hydrolysis unit to supply water to said hydrolysis unit.

25. The system of claim 18, further comprising a groundwater supply unit being associated with said hydrolysis unit to supply water to said hydrolysis unit.

26. The system of claim 18, wherein said hydrolysis unit has a nominal power which is less than approximately 10 percent of the nominal power of said fuel cell.

27. The system of claim 18, wherein said hydrolysis unit includes a polymer electrolyte membrane.

28. The system of claim 18, further comprising a condenser battery being designed and arranged to serve as an electric energy storage unit.

29. A method of uninterruptedly supplying power during failure of a main power supply, comprising the steps of:
locally producing hydrogen from water in a hydrolysis unit;
locally storing the hydrogen; and
locally producing power by cold oxidation of the hydrogen to water.

30. The method of claim 29, further comprising the steps of:
producing a storage fluid from the locally produced hydrogen;
recovering the hydrogen from the storage fluid, and
supplying the hydrogen to a fuel cell.
